(19) United States
(12) Patent Application Publication
(10) Pub. No.: US 2012/0267218 A1
(43) Pub. Date: Oct. 25, 2012

(54) Device For Feeding Book Blocks To A Book Binding Machine

(76) Inventors: Martin Nolte, Rahden (DE); Dirk Rygol, Rheine (DE)

(21) Appl. No.: 13/452,213

(22) Filed: Apr. 20, 2012

(30) Foreign Application Priority Data
Apr. 23, 2011 (DE) 10 2011 018 509.7

(51) Int. Cl. B65G 37/00

(52) U.S. Cl. 198/610

(57) ABSTRACT

In a feed device (1) for a perfect binder, it is proposed that the conveying device (30) features at least one clamping carriage (31.1 . . . 4) that takes hold of sheet stacks (2) that were aligned in the vibrator device (5) and stand on the block spine (2 a) laterally on the block spine (2 a) by means of clamping strips (33.1, 33.2) and supports the block spine (2 a) on supporting plates (32), wherein this clamping carriage receives the sheet stacks from an inclined designated position (21) and horizontally transfers said sheet stacks to the book block conveying device. The sheet stacks (2) are no longer pushed into the perfect binder through a channel, but rather transported by the clamping carriage (31.1 . . . 4) in a laterally clamped fashion.

### BACKGROUND

The invention pertains to a device for feeding book blocks to a book binding machine.

In book binding machines that are known as perfect binders, perfect-bound brochures or book blocks for hard covers are produced, wherein the glue is applied on the previously processed spine of the book blocks and a cover and/or a lining strip is placed around and pressed against the block spine. Various binding processes and product variations can be realized depending on the equipment of the perfect binder.

DE 20 2005 007 012 U1 describes such a book binding machine with a book block conveying device consisting of an endless conveying means that continuously revolves around guide rollers and a plurality of clamps for clamping book blocks that are arranged on the conveying means in such a way that they are equidistantly spaced apart from one another. Various processing stations are arranged along straight conveying sections of the oval. There also exist linearly operating perfect binders with a clamping plate conveyor consisting of two revolving plate chains, between which the book blocks are clamped at fixed distances from one another and transported.

The loose book blocks reach the perfect binder via a transfer channel, wherein the book blocks are continuously pushed forward in a channel with a bottom and lateral guide walls by transport bars and pass one or more vibrator stations during this process. In this case, the book blocks are guided over vibrating plates while they stand on their spine and are transported in the longitudinal direction of the spine in order to be aligned in the spine and at the head such that the all folded sections and/or individual sheets lie in one plane.

However, such a transfer of the book blocks is associated with certain problems, particularly in the processing of book blocks that are exclusively composed of individual sheets and/or quarter sections and typically produced in digital printing systems. The outer sheets have a tendency to travel upward on the guide walls or to creep underneath the block spine or to place themselves between the transporter and the head of the book block while it is pushed forward. Individual sheets that already protrude during the infeed of the book block cannot be sufficiently forced back into the sheet stack and aligned while the book block is pushed forward over the vibrator section such that prior straightening of the book blocks is required in connection with a careful and therefore laborious insertion of the sheet stack into the transfer channel. Furthermore, individual sheets or block sections may shoot forward when the machine is stopped.

In other known systems, a robot equipped with a gripper picks up book blocks that were aligned on a stationary vibrating table and places the book blocks into a stationary clamp [Professional Article “Über 4.000 Produkte am Tag: Klebebindung inn Akkord mit Roberto;” Deutscher Drucker, No. 26, Aug. 19, 2000, Page 25]. The complicated transfer system is only suitable for perfect binders of the lower capacity range, in which the clamps are driven intermittently. In addition, the robot merely picks up the book blocks in a laterally clamped fashion such that block sections may shift and the previously realized alignment may be lost.

### SUMMARY

The present invention is based on the objective of developing a device for feeding book blocks to a book binding machine, which device has a simple construction and also allows the flawless alignment and transfer of sheet stacks or book blocks that are composed, in particular, of individual sheets at higher production speeds. As used herein, “sheet stacks” includes folded sections, quarter sections and/or individual sheets.

This objective is attained in that the conveying device features at least one clamping carriage that takes hold of sheet stacks that were aligned in the vibrator device and stand on the block spine laterally on the block spine by means of clamping strips and supports the block spine on supporting plates, wherein this clamping carriage receives the sheet stacks from an inclined designated position and horizontally transfers the sheet stacks to the book block conveying device.

The sheet stacks are no longer pushed into the perfect binder through a channel, but rather transported in a laterally clamped fashion by a clamping carriage. The prior alignment of the sheet stacks realized in the upstream vibrator device is preserved. A flawless transport by means of the clamping carriage is ensured due to the fact that the sheet stacks are not only laterally clamped, but also supported by supporting plates of the clamping carriage. The clamping force to be generated can be limited to a minimum in order to protect the product. The height of the clamping strips that laterally engage on the block spine can be maintained so small that the sheet stacks can be transported in a gripped fashion as far as the clamps or the clamping plate conveyor of the book block conveying device without being prematurely released and remain in the clamps or the clamping plate conveyor until it is closed such that a positive transfer is ensured and potential shifting of the block is precluded. The sheet stacks are received by the clamping carriage in the inclined orientation, in which a stable position of the sheet stacks is ensured, and not turned into the horizontal block spine opposition until they have been received by the clamping carriage.

A flawless alignment can be achieved if the vibrator device features vibrating plates that are inclined relative to the horizontal line and arranged perpendicular to one another, wherein the sheet stacks are aligned on these vibrating plates while standing on their sheet edges. The aligned sheet stacks can be easily transported into the designated position by means of transversely displaceable guide plates. It is preferred to form a settling area in the designated position of the vibrator device by providing the designated position with rigid supporting plates that are connected to the vibrating plates with interengaging tabs and/or obliquely extending joints. The sheet stacks can be received by the clamping carriage due to the fact that the supporting plates leave a front section of the sheet stacks exposed in the designated position.

The opening width of the clamping strips of the at least one first vibrating plate of a clamping carriage preferably can be pre-adjusted in accordance with the respective block thickness of the sheet stack to be received. Due to this measure, only a small moving space is required in the area, in which the sheet stacks are received.

According to a preferred additional development, at least one clamping carriage is driven intermittently and has a standstill phase for receiving stationary sheet stacks from the designated position and a synchronous phase with the book block conveying device during the transfer. The reception at a standstill ensures the previously realized alignment and the transfer to the moving book block conveying device makes it possible to realize high feed capacities.

According to a preferred additional development, a revolving conveyor system of several successively arranged clamping carriages is provided such that even higher feed capacities can be achieved while simultaneously extending the standstill phases and the synchronous phases. In order to independently drive successive clamping carriages, the clamping carriages are alternately coupled to at least two separately driven conveying means. Referred to the conveying direction, the revolving clamping carriage includes multiple elements and is flexible in a first direction, but transversely stable in a second direction. The thusly segmented clamping strips can be successively opened and/or closed. It is preferred that a first section of the segmented clamping strips can be closed in order to receive a sheet stack while the at least one clamping carriage is at a standstill and the following sections are respectively closed after the clamping carriage has traveled a corresponding distance. A front section of the sheet stacks that is left exposed by the supporting plates therefore is securely taken hold of at a standstill without shifting and following clamping sections are closed at a slow conveying speed such that the sheet stacks can ultimately be transported away in a highly accelerated fashion. During the transfer of the sheet stacks to the book block conveying device, all sections of the segmented clamping strips preferably are opened simultaneously. In this way, it is possible to realize a shorter transfer section that also positively affects the length of the perfect binder.

### BRIEF DESCRIPTION OF THE DRAWING

Aspects of the invention are described below with reference to one exemplary embodiment shown in the drawing, wherein

FIG. 1 shows a perspective view of a feed device for a perfect binder with a vibrator device that is realized in the form of a revolving pocket conveyor system and a revolving clamping carriage conveyor;

FIG. 2 shows a front view of the feed device according to

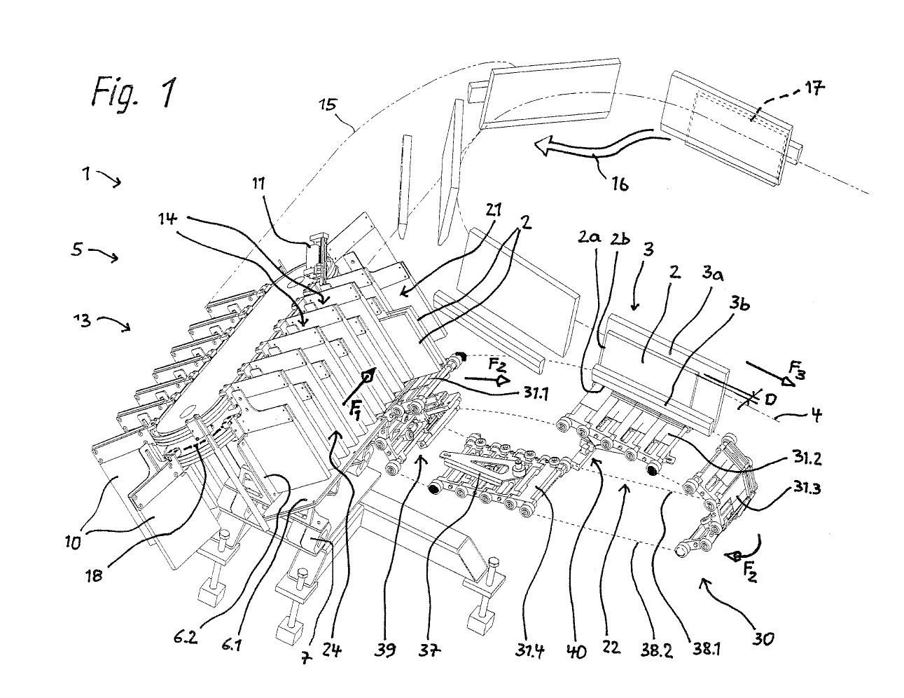

FIG. 1;

FIG. 3 shows a top view of the vibrating plates of the vibrator device;

FIG. 4 shows a side view of the vibrator device;

FIG. 5 shows a second perspective view of the pocket conveyor system;

FIG. 6 shows a detail of the pocket conveyor system, and

FIGS. 7a,b show perspective top and bottom views of a clamping carriage.

### DETAILED DESCRIPTION

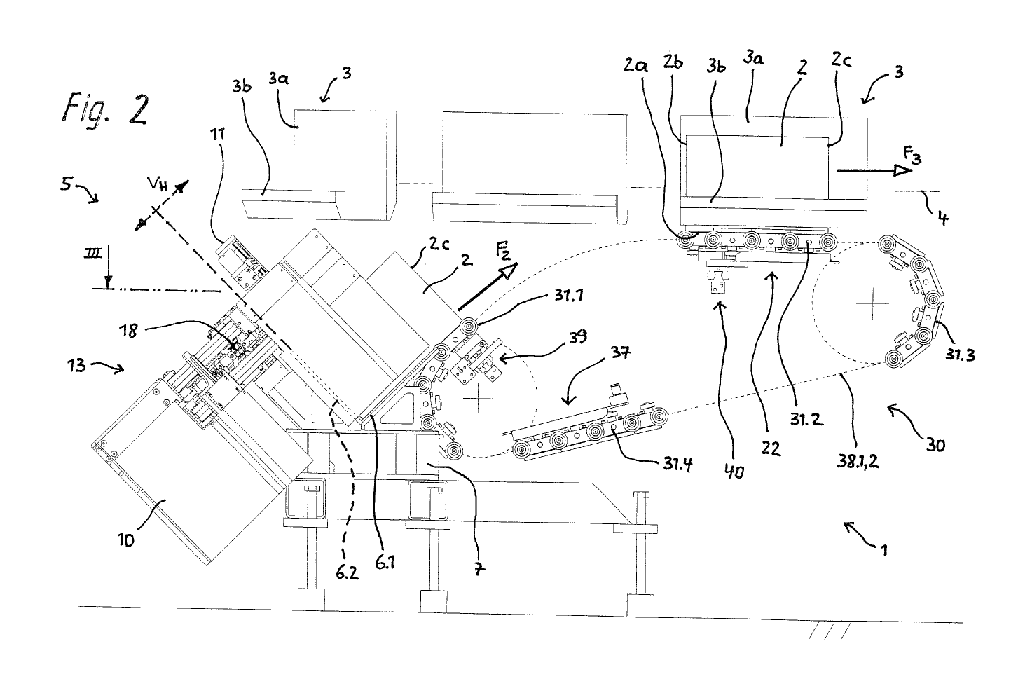

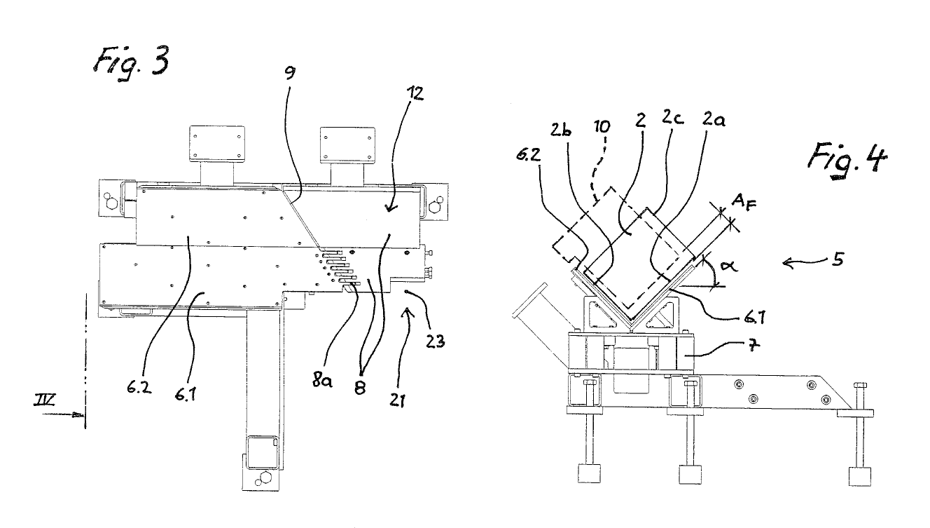

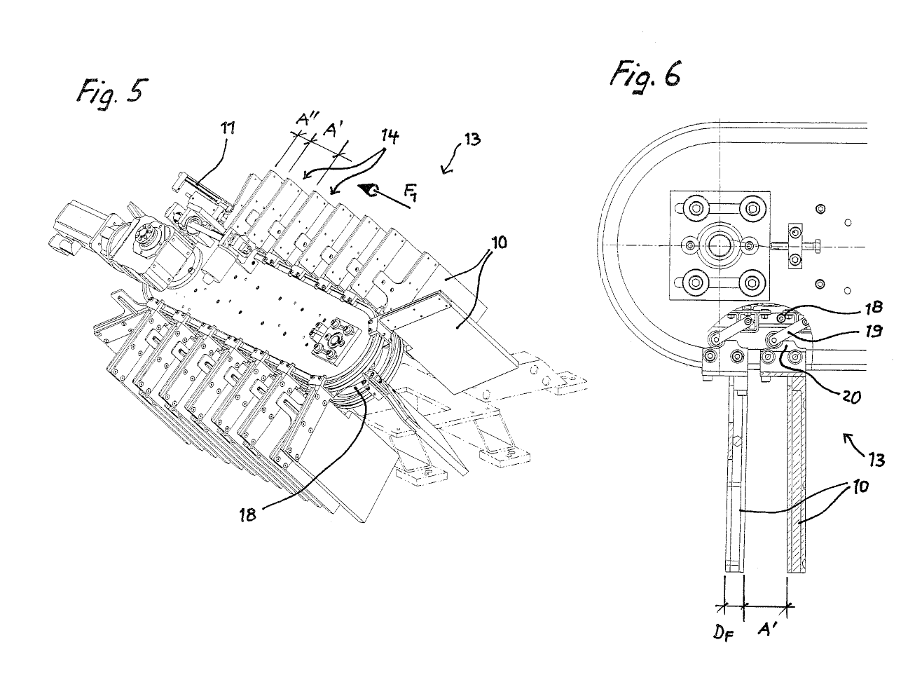

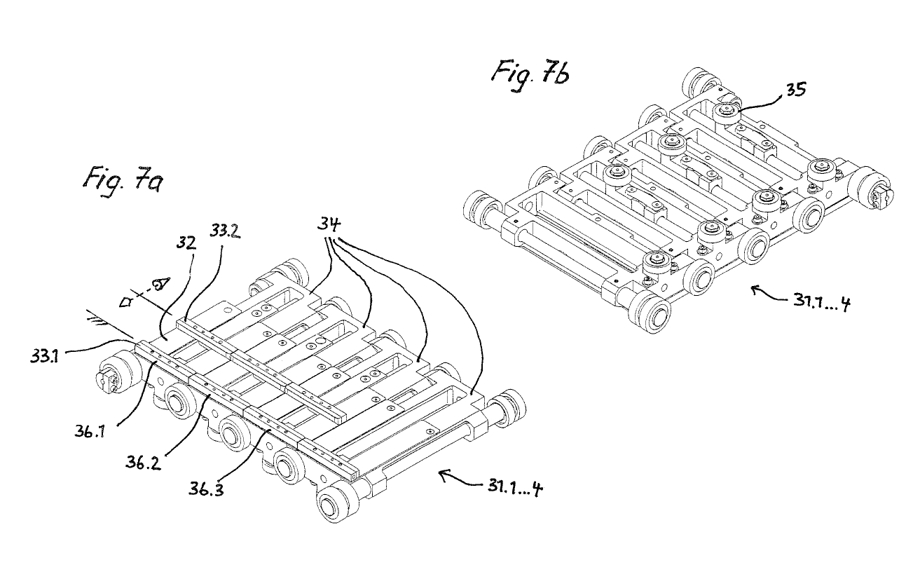

FIGS. 1 and 2 show part of a perfect binder that consists of a book block transport system with a plurality of block clamps 3 that can be continuously moved along a closed oval track in a conveying direction F3 and are equidistantly coupled to and driven by a conveyor chain 4, with a feed device 1 for feeding sheet stacks that are predominantly composed of individual sheets and/or quarter sections or so-called loose book blocks 2, and with a delivery area 16 that is symbolically illustrated in the form of an arrow and serves for delivering brochures 17 or book blocks that were perfect-bound in the perfect binder. Various stations that are not illustrated in detail in FIGS. 1 and 2 and serve for processing and gluing the spine, as well as for applying and pressing on covers, are arranged along straight conveying sections of the oval track.

The block clamps 3 may consist of block clamps that close in a parallel fashion and feature an inner stationary clamping jaw 3 a and an outer clamping jaw 3 b that can be displaced perpendicular to the inner clamping jaw 3 a or of block clamps that can be pivoted open in a translatory fashion and in which the outer clamping jaw 3 b can be moved relative to the inner stationary clamping jaw 3 a by means of a pivot arm. In the region of the deflection illustrated in FIG. 1, opened block clamps 3 travel from the delivery area to a transfer area 22, in which the book blocks 2 supplied by the feed device 1 are received by closing the block clamps 3 and further transported, wherein the edge of block spine 2 a downwardly protrudes from the block clamps 3 by a defined distance. The head 2 b of the book blocks 2 lies at the rear referred to the conveying direction F3.

The perfect binder may also consist of a linearly operating perfect binder with a clamping plate conveyor consisting of two revolving plate chains, between which the book blocks are clamped within fixed distances from one another and transported.

According to the present disclosure, the feed device 1 includes a separate vibrator device 5 for aligning sheet stacks or unbound book blocks 2 supplied by a manual feed or a coupling to upstream machines such as a gathering machine or a digital printing machine, as well as a clamping carriage conveyor 30 for transferring the book blocks 2 aligned in the vibrator device 5 into the block clamps 3.

The vibrator device 5 features first and second vibrating plates 6.1, 6.2 that are mounted on oscillatory elements 7, wherein these vibrating plates are arranged perpendicular to one another and inclined relative to the horizontal line by an angle α of preferably 45°. The loose book blocks 2 stand on the first vibrating plate 6.1 with first sheet edges in the form of their block spine 2a and contact the aligning element in the form of a second vibrating plate 6.2 with different, second sheet edges, in this case the head 2 b of the book block 2. The lateral guidance is realized with guide plates 10.

The vibrator device 5 is realized in the form of a revolving pocket conveyor system 13. A plurality of guide plates 10 are coupled to a revolving conveyor chain 18, wherein a receptacle pocket 14 is respectively formed between successive guide plates 10. The pocket conveyor system 13 has a conveying direction F1. Book blocks 2 supplied in the area of a manual feed 24 are successively transported into a designated position 21 and transversely displaced over the vibrating plates 6.1, 6.2 during this process.

According to FIG. 3, the vibrating plates 6.1, 6.2 do not extend over the entire length of the vibrator device 5. They end in front of the designated position 21. Rigid plates 8 are connected to the vibrating plates 6.1, 6.2 with interengaging tabs 8 a and obliquely extending joints 9 and form a settling area 12, in which the aligned book blocks 2 become stationary in order to be flawlessly received by the clamping carriage conveyor 30. The vibrating plates 6.1, 6.2 may also extend into the settling area 12, wherein only slight vibration intensity would exist in the settling area 12 and reduce the friction during the transverse transport into the designated position 21, as well as allow the transfer of the aligned book blocks 2 from a quasi-stationary position.

The guide plates 10 are engaged on driving cams 20 of the conveyor chain 18 by means of spring-connected roller levers 19 such that a certain distance N is defined between the guide plates. The guide plates 10 can be disengaged from the conveyor chain 18 and held in certain positions by actuating means such that a distance A″ that is adapted to the block thickness D can be adjusted between the guide plates 10.

FIGS. 1, 2 and 5 show an actuating element 11 that is arranged above the pocket conveyor system 13 and makes it possible to respectively hold a front guide plate 10 in the designated position 21 while the trailing rear guide plate 10 is additionally moved by the conveyor chain 18, the drive of which is controlled in dependence on the block thickness D and the cycle of the perfect binder, until the book block 2 is laterally clamped in this receptacle pocket 14.

Additional actuating elements are respectively provided underneath and within the pocket conveyor system 13. In the designated position 21, from which an aligned book block 2 is transported away by means of the clamping carriage conveyor 30, the guide plates 10 therefore can initially be held in a tight guide position, the dimensions of which are adjusted in accordance with the block thickness D, then displaced into a clamping position, in which the aligned (individual) sheets of the book block 2 are clamped between the two guide plates 10, and ultimately displaced into a release position after the book block 2 has been received by the clamping carriage conveyor 30.

After a book block 2 has been received by the clamping carriage conveyor 30, the front guide plate 10 once again engages into the conveyor chain 18 in order to return into the area of the manual feed 24, in which new book blocks 2 can be placed into the receptacle pockets 14. The guide plates 10 may also be alternately coupled to two separately driven conveyor chains. In this case, the receptacle pockets 14 lie between the first and the second guide plate 10, between the third and the fourth guide plate, etc., wherein the first guide plate 10, the third guide plate, etc. are coupled to the first conveyor chain and the second guide plate, the fourth guide plate, etc. are coupled to the second conveyor chain. A distance A′ that is adapted to the block thickness D can then be adjusted in the receptacle pockets 14 by shifting the phase of the second conveyor chain relative to the first conveyor chain.

The second vibrating plate 6.2 can be adjusted in accordance with the adjustment arrow VH together with the pocket conveyor system 13. This ensures that the foot 2 c of the book block 2 still lies in the region of the outer edge of the vibrating plate 6.1 when the format height of the book blocks is changed such that the book blocks 2 can be received by the clamping carriage conveyor 30.

The clamping carriage conveyor 30 features a total of four clamping carriages 31.1 . . . 4 that successively revolve around the closed track in a conveying direction F2. According to FIGS. 7a and b, each clamping carriage 31.1 . . . 4 has clamping carriage elements 34 that are connected to one another in an articulated fashion and flexible in a first direction, but transversely stable in a second direction. Supporting plates 32 are provided in the clamping carriages 31.1 . . . 4 and support the block spine 2 a of the book blocks 2 to be transferred while they are laterally clamped at the block spine by clamping strips 33.1, 33.2. The individual clamping sections 36.1 . . . 3 formed in accordance with the clamping carriage elements 34 can be opened and closed by actuating control rollers 35 arranged on the underside. Since the perfect binder features stationary inner clamping jaws 3 a, first clamping strips 33.1 are also arranged stationarily and second clamping strips 33.2 are arranged displaceably on the clamping carriages 31.1 . . . 2. It would also be possible to arrange both clamping strips 33.1 and 33.2 displaceably.

A pre-adjusting device 37 makes it possible to adjust the opening width of the clamping strips 33.1, 33.2 in accordance with the block thickness D of the book block 2 to be received. In this case, the clamping carriages 31.1 . . . 4 move into the designated position 21 of the vibrator device 5 from underneath through an opening 23. During this process, the clamping strips 33.1, 33.2 are able to move in the respective space between the book blocks 2 that is defined by a certain thickness DF of the guide plates 10 and their distance AF from the vibrating plate 6.1. The individual clamping sections 36.1 . . . 3 are then successively closed by means of a closing device 39.

The clamping carriages 34.1 . . . 4 are driven intermittently and have a standstill phase, in which the first clamping section 36.1 is closed. The respective clamping carriage 31.1 . . . 4 with the book block 2 clamped in the first clamping section 36.1 is then advanced with a relatively slow speed, wherein a respectively following clamping section 36.2 . . . 3 is closed during the conveying motion of the clamping carriage 34.1 . . . 4 as soon as it approaches the block spine 2 a. After all clamping sections 36.1 . . . 3 have been closed, the clamping carriage 31.1 . . . 4 can be moved to the block clamps 3 with a significantly accelerated speed, wherein the book block 2 is inserted into the open block clamp 3 from underneath. During a synchronized phase with the block clamp 3 moving with a constant speed in the transfer area 22, the block clamp 3 is initially closed and all clamping strips 33.1, 33.2 are subsequently opened over all clamping sections 36.1 . . . 3 by means of the opening device 40. This means that the book blocks 2 are no longer released after they were received from the vibrator device 5 until they are firmly clamped in the block clamps 3 such that a so-called positive transfer is achieved.

In order to respectively drive the four successively revolving clamping carriages 31.1 . . . 4 in the above-described fashion and to furthermore allow a position-dependent placement of the book block 2 in the block clamp 3, successive clamping carriages 31.1 and 31.2 or 31.2 and 31.3, etc., are respectively coupled to conveyor chains 38.1, 38.2 that are driven independently of one another. The clamping carriages 31.1 and 31.3 are coupled to the conveyor chain 38.1 and the clamping carriages 31.2 and 31.4 are coupled to the conveyor chain 38.2.

In FIG. 1, the broken lines 15 indicate an additional development of the invention, in which the pocket conveyor system 13 is extended as far as the delivery area 16 of the perfect binder. Brochures 17 or book blocks that were perfect-bound in the perfect binder can be placed into the receptacle pockets 14 and remain therein in order to dry, wherein the brochures or book blocks may, if applicable, be transported as far as the manual feed 24 of the book blocks such that one worker can handle the feeding of the book blocks 2, as well as the removal of bound brochures 17.

1. A device for feeding book blocks (2) in the form of sheet stacks (2) to a book binding machine, comprising
a continuously driven book block conveying device (4) with clamping elements (3) that laterally clamp the sheet stacks (2), with a stack spine edge (2a) downwardly protruding from the clamping elements (3),
a vibrator device (5) for aligning the sheet stacks (2), and
a transfer conveying device (30) for the synchronous transfer of the sheet stacks (2) to the book block conveying device,
wherein the transfer conveying device (30) includes at least one clamping carriage (31.1 . . . 4) that takes hold of sheet stacks (2) that were aligned in the vibrator device (5) and that stand on the stack spine edge (2a), by laterally clamping at the stack spine with clamping strips (33.1, 33.2) and supporting the stack spine edge (2a) on supporting plates (32), and wherein said clamping carriage (31.1 . . . 4) receives the sheet stacks from an inclined designated position (21) and horizontally transfers said sheet stacks to the book block conveying device.

2. The device according to claim 1, wherein
the vibrator device (5) includes vibrating plates (6.1, 6.2) that are inclined relative to horizontal and arranged perpendicular to one another;
the sheet stacks (2) are aligned on said vibrating plates while standing on their sheet edges (2a, 2b); and
the aligned sheet stacks (2) can be moved into the designated position (21) by transversely displaceable guide plates (10).

3. The device according to claim 2, wherein the designated position (21) is provided with rigid supporting plates (8) that are connected to the vibrating plates (6.1, 6.2) with at least one of interengaging tabs (8 a) or obliquely extending joints (9).

4. The device according to claim 2, wherein the supporting plates (8) leave a front section of the sheet stacks (2) exposed in the designated position (21) in order to receive the sheet stacks (2).

5. The device according to claim 1, wherein the clamping strips (33.1, 33.2) of the at least one clamping carriage (31.1 . . . 4) have an opening width which can be pre-adjusted in accordance with a respective block thickness (D) of the sheet stack (2) to the received.

6. The device according to claim 1, wherein the at least one clamping carriage (31.1 . . . 4) is driven intermittently and has a standstill phase for receiving stationary sheet stacks (2) from the designated position (21) and a synchronous phase with the book block conveying device during the transfer (22).

7. The device according to claim 1, wherein the transfer conveyor is a revolving conveyor system (30) with several successively arranged clamping carriages (31.1 . . . 4).

8. The device according to claim 7, wherein the clamping carriages (31.1 . . . 4) are alternately coupled to at least two separately driven conveyors (38.1, 38.2).

9. The device according to claim 7, wherein each clamping carriage (31.1 . . . 4) comprises several spine support elements aligned side by side in the conveying direction (F₂) and segmented clamping strips (33.1, 33.2) aligned end-to-end in the conveying direction that can be successively opened and/or closed to clamp the space.

10. The device according to claim 9, wherein a first section (36.1) of the segmented clamping strips (33.1, 33.2) can be closed in order to receive a sheet stack (2) while the at least one clamping carriage (31.1 . . . 4) is at a standstill and the following sections (36.1, 36.2) are respectively closed after the clamping carriage (31.1 . . . 4) has traveled a corresponding distance.

11. The device according to claim 9, wherein all sections (36.1 . . . 3) of the segmented clamping strips (33.1, 33.2) are simultaneously opened during the transfer to the book block conveying device.
